(19) United States
(12) Patent Application Publication
(10) Pub. No.: US 2026/0089773 A1
(43) Pub. Date: Mar. 26, 2026

(54) RANDOM ACCESS CHANNEL COLLISION HANDLING THROUGH MULTIPLE TRANSMIT POWER CONTROL COMMANDS

(71) Applicant: QUALCOMM Incorporated, San Diego, CA (US)

(72) Inventors: Raviteja PATCHAVA, San Diego, CA (US); Xiaoxia ZHANG, San Diego, CA (US); Jing SUN, San Diego, CA (US); Junyi LI, Greentown, PA (US); Jing JIANG, San Diego, CA (US)

(21) Appl. No.: 18/895,257

(22) Filed: Sep. 24, 2024

(51) Int. Cl. H04W 74/0833; H04W 52/14

(52) U.S. Cl. CPC H04W 74/0858; H04W 52/146

(57) ABSTRACT

Various aspects of the present disclosure generally relate to wireless communication. In some aspects, a user equipment (UE) may transmit, to a network node, a physical random access channel (PRACH) message. The UE may receive, from the network node, a random access response (RAR) indicating a set of transmit power control (TPC) values. The UE may transmit, to the network node, a physical uplink shared channel (PUSCH) message using a TPC value selected from the set of TPC values. Numerous other aspects are described.

### FIELD OF THE DISCLOSURE

Aspects of the present disclosure generally relate to wireless communication and specifically relate to techniques, apparatuses, and methods for random access channel collision handling through multiple transmit power control commands.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include transmitting, to a network node, a physical random access channel (PRACH) message. The method may include receiving, from the network node, a random access response (RAR) indicating a set of transmit power control (TPC) values. The method may include transmitting, to the network node, a physical uplink shared channel (PUSCH) message using a TPC value selected from the set of TPC values.

Some aspects described herein relate to a method of wireless communication performed by a network node. The method may include receiving a first PRACH message associated with a PRACH resource and a second PRACH message associated with the PRACH resource. The method may include transmitting, in response to the first PRACH message and the second PRACH message, an RAR indicating a set of TPC values. The method may include receiving a first PUSCH message and a second PUSCH message, wherein the first PUSCH message and the second PUSCH message are associated with different TPC values from the set of TPC values.

Some aspects described herein relate to a UE for wireless communication. The UE may include one or more memories and one or more processors coupled to the one or more memories. The one or more processors may be configured to transmit, to a network node, a PRACH message. The one or more processors may be configured to receive, from the network node, an RAR indicating a set of TPC values. The one or more processors may be configured to transmit, to the network node, a PUSCH message using a TPC value selected from the set of TPC values.

Some aspects described herein relate to a network node for wireless communication. The network node may include one or more memories and one or more processors coupled to the one or more memories. The one or more processors may be configured to receive a first PRACH message associated with a PRACH resource and a second PRACH message associated with the PRACH resource. The one or more processors may be configured to transmit, in response to the first PRACH message and the second PRACH message, an RAR indicating a set of TPC values. The one or more processors may be configured to receive a first PUSCH message and a second PUSCH message, wherein the first PUSCH message and the second PUSCH message are associated with different TPC values from the set of TPC values.

Some aspects described herein relate to a non-transitory computer-readable medium that stores a set of instructions for wireless communication by a UE. The set of instructions, when executed by one or more processors of the UE, may cause the UE to transmit, to a network node, a PRACH message. The set of instructions, when executed by one or more processors of the UE, may cause the UE to receive, from the network node, an RAR indicating a set of TPC values. The set of instructions, when executed by one or more processors of the UE, may cause the UE to transmit, to the network node, a PUSCH message using a TPC value selected from the set of TPC values.

Some aspects described herein relate to a non-transitory computer-readable medium that stores a set of instructions for wireless communication by a network node. The set of instructions, when executed by one or more processors of the network node, may cause the network node to receive a first PRACH message associated with a PRACH resource and a second PRACH message associated with the PRACH resource. The set of instructions, when executed by one or more processors of the network node, may cause the network node to transmit, in response to the first PRACH message and the second PRACH message, an RAR indicating a set of TPC values. The set of instructions, when executed by one or more processors of the network node, may cause the network node to receive a first PUSCH message and a second PUSCH message, wherein the first PUSCH message and the second PUSCH message are associated with different TPC values from the set of TPC values.

Some aspects described herein relate to an apparatus for wireless communication. The apparatus may include means for transmitting, to a network node, a PRACH message. The apparatus may include means for receiving, from the network node, an RAR indicating a set of TPC values. The apparatus may include means for transmitting, to the network node, a PUSCH message using a TPC value selected from the set of TPC values.

Some aspects described herein relate to an apparatus for wireless communication. The apparatus may include means for receiving a first PRACH message associated with a PRACH resource and a second PRACH message associated with the PRACH resource. The apparatus may include means for transmitting, in response to the first PRACH message and the second PRACH message, an RAR indicating a set of TPC values. The apparatus may include means for receiving a first PUSCH message and a second PUSCH message, wherein the first PUSCH message and the second PUSCH message are associated with different TPC values from the set of TPC values.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example network node in communication with an example user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a four-step random access procedure, in accordance with the present disclosure.

FIG. 5 is a diagram illustrating an example of physical random access channel (PRACH) collision and message 3 (MSG3) collision in a four-step, contention-based random access channel (RACH) procedure, in accordance with the present disclosure.

FIGS. 6A-6C are diagrams illustrating examples associated with detection of PRACH collision, in accordance with the present disclosure.

FIGS. 7-9 are diagrams illustrating examples associated with RACH collision handling through multiple transmit power control (TPC) commands, in accordance with the present disclosure.

FIG. 10 is a diagram illustrating an example process performed, for example, at a UE or an apparatus of a UE, in accordance with the present disclosure.

FIG. 11 is a diagram illustrating an example process performed, for example, at a network node or an apparatus of a network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, a random access channel (RACH) procedure may refer to a sequence of steps for establishing or re-establishing communication between a network node and a user equipment (UE). For example, the RACH procedure may be utilized to achieve downlink (DL) and/or uplink (UL) synchronization between a UE and a network node and/or to obtain resources for a radio resource control (RRC) connection request. To configure the RACH procedure, the network node may broadcast configuration and synchronization information to UEs, including a set of preamble sequences that each UE may use to establish or re-establish a connection with the network node. For example, the network node may transmit one or more synchronization signal blocks (SSBs) and/or random access configuration information, which includes parameters to be used in the RACH procedure, including the set of potential preamble sequences shared among UEs. In response, a UE may select a PRACH resource (e.g., a preamble sequence and/or a RACH occasion (RO) in which to transmit the PRACH) to transmit a message (e.g., a message 1, also referred to as a msg1 or a MSG1) that includes a preamble sequence selected from the set of potential preamble sequences, thus enabling the network node to potentially identify and further communicate with the UE.

In response to receiving the UE message including the selected preamble sequence, the network node may transmit a random access response (RAR) (e.g., a message 2, also referred to as a msg2 or MSG2) indicating the preamble detected in the MSG1 from the UE and including an initial RAR UL grant for the UE. The UE may then use the UL grant provided in the MSG2 to transmit a MSG3 on a physical uplink shared channel (PUSCH) (e.g., a PUSCH message), including, for example, an RRC message and/or other data. After receiving and processing the MSG3, the network node may then transmit a MSG4 to the UE that confirms the identity of the UE and provides the UE with a cell radio network temporary identifier (C-RNTI). Following receipt of the MSG4, the UE and the network node may continue communication via the wireless network.

When two or more UEs are present in the wireless network, the network node may distinguish between UEs by determining the PRACH resources that each UE uses to transmit a MSG1. For example, when the network node transmits an RAR UL grant in a MSG2 to a UE, the network node may use the PRACH resource that the UE used to transmit the MSG1 to calculate a temporary identification to distinguish the UE from other UEs in the wireless network (e.g., a random access radio network temporary identifier (RA-RNTI) that is calculated according to various parameters associated with the PRACH resource used for the MSG1 transmission).

However, when two UEs transmit a MSG1 to the network node using the same PRACH resource, the network node may be unable to distinguish between the two UEs, leading to collisions during the RACH procedure. As a result, a PRACH collision may occur when two UEs select the same PRACH resource to transmit a PRACH (e.g., via MSG1) at approximately the same time. For example, when multiple MSG1s are transmitted in the same RO and the multiple MSG1s include the same preamble, the network node may consider that only a single UE has been detected, and may send out a single MSG2 that includes an RAR UL grant. Each of the two UEs that transmitted the MSG1 using the PRACH resource will consider the MSG2 as addressed to itself where, for example, the RAR UL grant includes a cyclic redundancy code (CRC) scrambled by the RA-RNTI associated with the RO used by both UEs for MSG1 and a random access preamble identifier (RAPID) associated with the preamble that both UEs used for MSG1.

Following receipt of the MSG2 at the two UEs, both UEs may use the same received RAR UL grant to transmit a MSG3 to the network node on a PUSCH, resulting in a MSG3 collision. The MSG3 collision may then require a contention resolution process to further distinguish the UEs and facilitate a connection with the network node. For example, the network node may decode the MSG3 received from only one of the two UEs and may transmit a single MSG4 with an identifier of the UE associated with the decoded MSG3. The other UE may also receive the MSG4 with the identifier of the UE associated with the decoded MSG3, and may then restart the RACH procedure (e.g., by transmitting a new MSG1) based on the UE identifier mismatch.

In such examples, there may be increased latency in a RACH procedure in which two or more UEs choose the same PRACH resource (e.g., the same RO and the same preamble sequence) for a PRACH transmission. Therefore, a PRACH collision during the RACH procedure may result in the repetition of multiple transmissions from one or more of the UEs as well as additional latency for establishing and/or re-establishing connection between each UE and the network node. Accordingly, this process may lead to increased network traffic, spectral inefficiency, and/or increased power consumption. For example, where two or more UEs are transmitting and/or re-transmitting messages due to a PRACH collision, these transmissions occupy network resources that may otherwise be used for other UEs and/or other transmissions. Similarly, where a PRACH collision occurs between two UEs, at least one of the UEs may need to repeat all or a part of the RACH procedure, resulting in additional power consumption.

Various aspects relate generally to a RACH collision handling procedure through the usage of multiple transmit power control (TPC) commands. Some aspects more specifically relate to a network node configuring a set of TPC values where each UE that transmits a preamble may select a TPC value from the set of TPC values for transmitting a MSG3 to the network node. In some aspects, the TPC values may be configured when a potential collision is detected by the network node (e.g., when the network node receives multiple MSG1s in the same RO with the same preamble, a delay or spatial beam difference between the multiple MSG1s satisfies a first threshold, and a power difference between the multiple MSG1s satisfies a second threshold. In some aspects, each TPC value may differ from other TPC values in the TPC value set by at least a threshold difference. In some aspects, the network node may configure a reference TPC value and a random offset and/or range that may be used to determine the set of TPC values. In some aspects, the network node may transmit a MSG2 associated with the set of TPC values when the potential collision is detected, and each UE may select a TPC value for a MSG3 transmission, such that the MSG3 transmissions are received at the network node with different power levels, enabling the network node to differentiate between the MSG3s. In some aspects, the network node may configure a set of TPC values and a set of scrambling parameters where different scrambling parameters correspond to different TPC values. In some aspects, the network node may transmit a MSG2 associated with the set of TPC values and the set of scrambling parameters, such that each UE may select a different TPC value and scrambling parameter for a MSG3 transmission, enabling the network node to differentiate between the MSG3s. In some aspects, the network node may transmit a MAC-CE containing multiple user resolution identities where each user resolution identity corresponds to one decoded MSG3 transmission from a UE. In some aspects, each user resolution identity may correspond to a decoded MSG3, such that each UE that receives the MSG4 can use the appropriate user resolution identity to complete the RACH procedure. In some aspects, after the network node has decoded a first MSG3 associated with a highest power level, the network node may perform successive interference cancellation (SIC) to cancel the impact of the first MSG3 and may thus proceed with decoding the MSG3 associated with the lower received power level, avoiding the requirement that one or more other UEs retransmit MSG1.

Particular aspects of the subject matter described in this disclosure can be implemented to realize one or more of the following potential advantages. In some examples, by providing a set of TPC values to UEs in a wireless network, the described techniques can be used to prevent and/or remedy collisions resulting from MSG3 transmissions from multiple UEs. Accordingly, by preventing and/or remedying RACH collisions (e.g., PRACH collisions and/or MSG3 collisions) between multiple UEs, some aspects may reduce network traffic, improve spectral efficiency, and/or reduce power consumption. Additionally, by providing a reference TPC value and an offset/range configuration for determining a set of TPC values, the network node can reduce the signaling overhead for providing the set of TPC values. Additionally, by enabling SIC, the network node may improve spectral efficiency, reduce network traffic, and reduce power consumption by detecting multiple MSG3s and thus avoid requiring one or more other UEs to retransmit MSG1.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

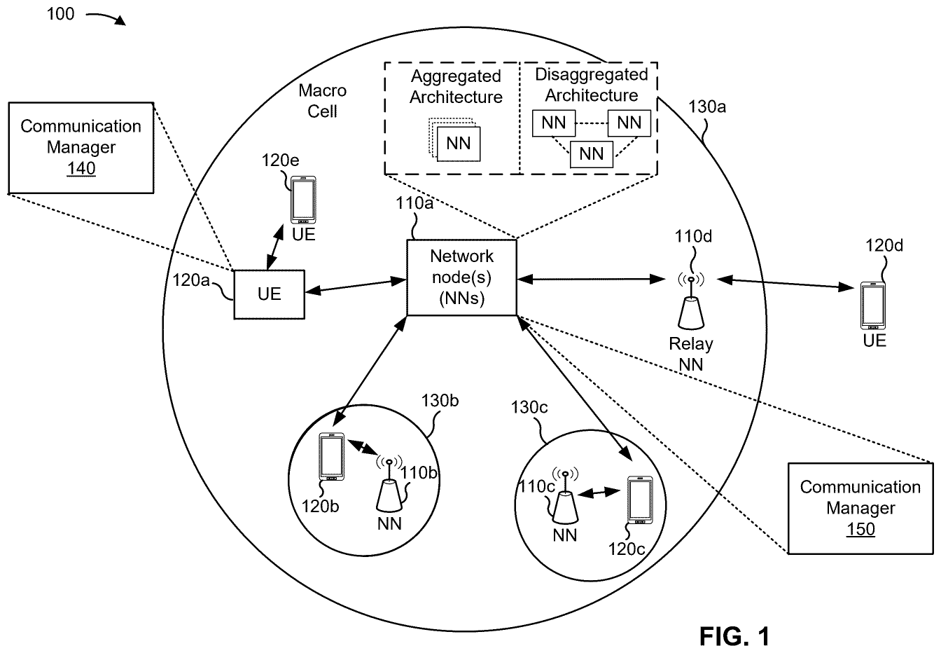

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHZ, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, PRACH extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally, or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more PUSCHs. The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally, or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally, or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may transmit, to a network node, a PRACH message; receive, from the network node, an RAR indicating a set of TPC values; and transmit, to the network node, a PUSCH message using a TPC value selected from the set of TPC values. Additionally, or alternatively, the communication manager 140 may perform one or more other operations described herein.

In some aspects, the network node 110 may include a communication manager 150. As described in more detail elsewhere herein, the communication manager 150 may receive a first PRACH message associated with a PRACH resource and a second PRACH message associated with the PRACH resource; transmit, in response to the first PRACH message and the second PRACH message, an RAR indicating a set of TPC values; and receive a first PUSCH message and a second PUSCH message, wherein the first PUSCH message and the second PUSCH message are associated with different TPC values from the set of TPC values. Additionally, or alternatively, the communication manager 150 may perform one or more other operations described herein.

As indicated above, FIG. 1 is provided as an example. Other examples may differ from what is described with regard to FIG. 1.

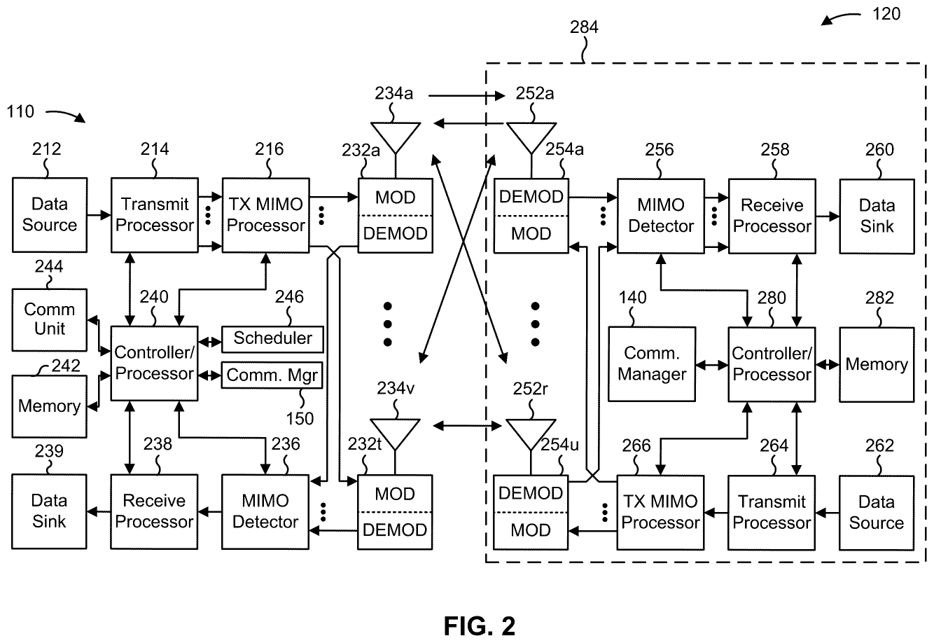

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a TPC parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

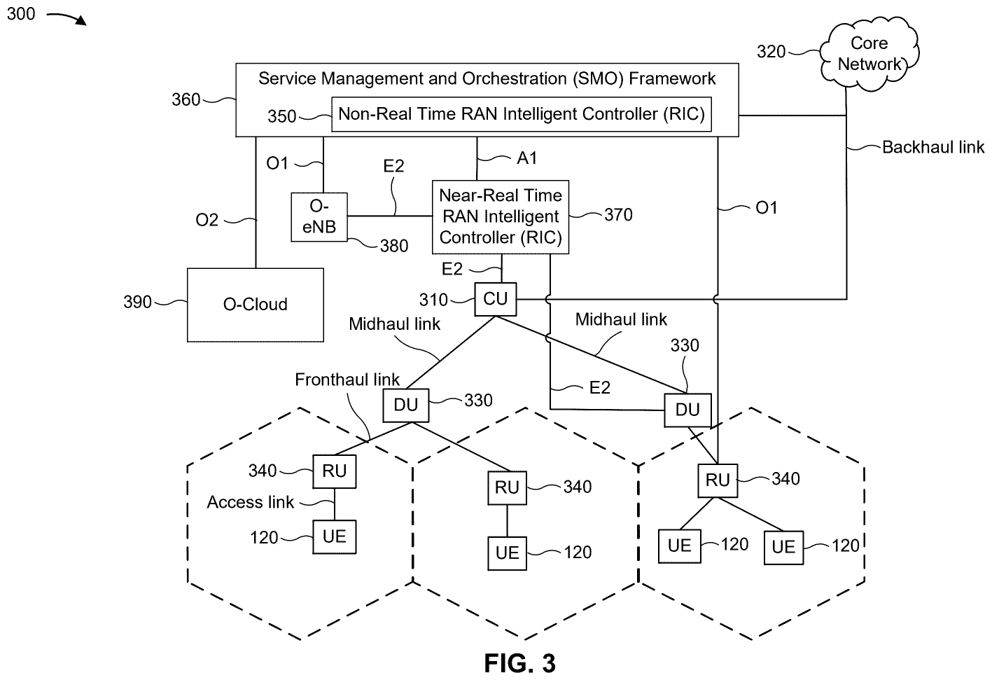

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUS 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-cNB) 380, via an O1 interface. Additionally, or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

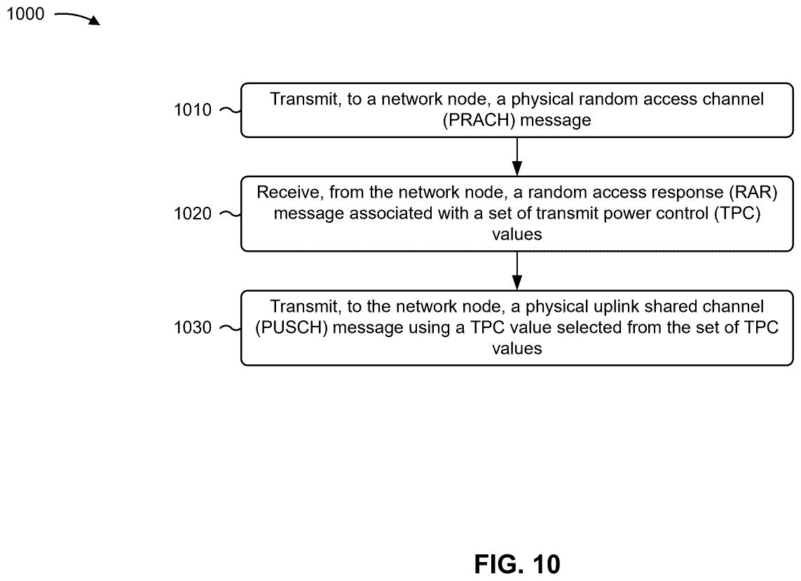

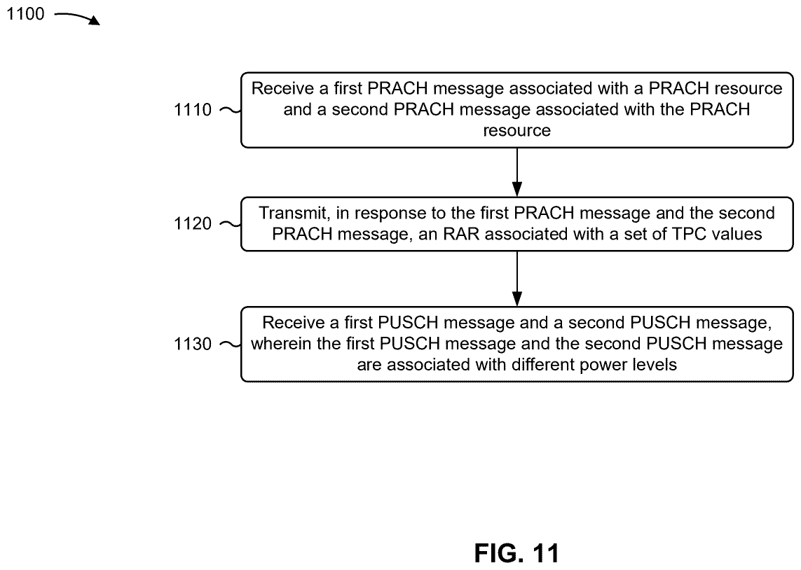

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with RACH collision handling through multiple TPC commands, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, the UE 120 includes means for transmitting, to a network node 110, a PRACH message; means for receiving, from the network node 110, an RAR indicating a set of TPC values; and/or means for transmitting, to the network node 110, a PUSCH message using a TPC value selected from the set of TPC values. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving a first PRACH message associated with a PRACH resource and a second PRACH message associated with the PRACH resource; means for transmitting, in response to the first PRACH message and the second PRACH message, an RAR indicating a set of TPC values; and/or means for receiving a first PUSCH message and a second PUSCH message, wherein the first PUSCH message and the second PUSCH message are associated with different TPC values from the set of TPC values. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

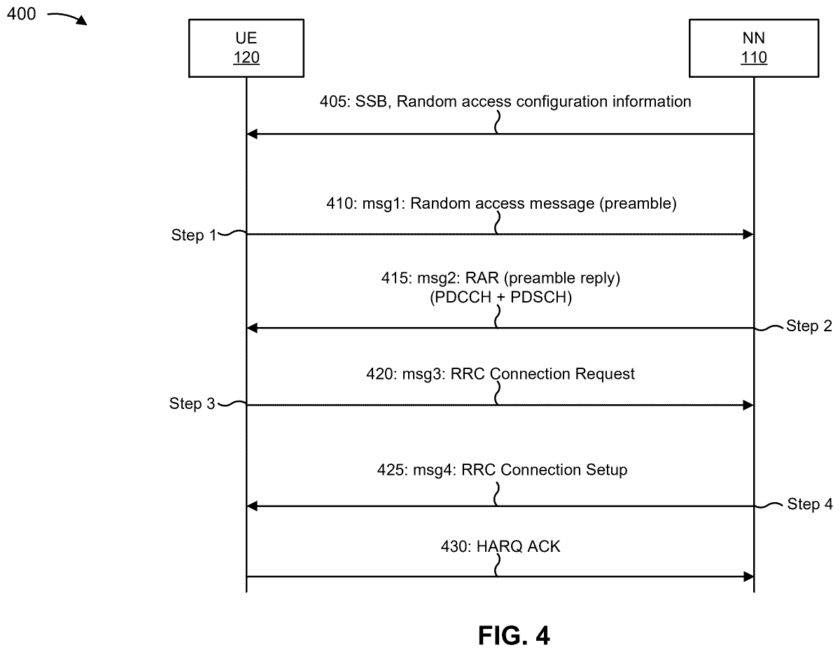

FIG. 4 is a diagram illustrating an example 400 of a four-step random access procedure, in accordance with the present disclosure. As shown in FIG. 4, a network node 110 and a UE 120 may communicate with one another to perform the four-step random access procedure.

As shown by reference number 405, the network node 110 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the random access procedure, such as one or more parameters for transmitting a random access message and/or one or more parameters for receiving an RAR.

As shown by reference number 410, the UE 120 may transmit a random access message, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier. In some examples, the random access configuration information may indicate a number of different preambles (e.g., a maximum of 64 preambles) that are available for selection. Where two or more UEs 120 select the same preamble and transmit a MSG1 in the same RO, a resulting PRACH collision may require a contention resolution procedure to enable the network node 110 to differentiate between the UEs 120.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation (e.g., an UL grant) to be used by the UE 120 to transmit message 3 (MSG3).

In some aspects, as part of the second step of the four-step random access procedure, the network node 110 may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC PDU of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (e.g., an RRC connection request). For example, where two UEs 120 selected the same PRACH resource (e.g., the same RO and the same preamble sequence) to transmit a MSG1, the network node 110 may transmit a single RAR UL grant to both UEs 120, resulting in a MSG3 collision where both UEs 120 utilize the same UL grant to transmit a MSG3. In such an example, a contention resolution process may be performed to enable the network node 110 to distinguish between the UEs 120.

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. Additionally, as shown by reference number 430, if the UE 120 successfully receives the RRC connection setup message, the UE 120 may transmit a hybrid automatic repeat request (HARQ) acknowledgement (ACK).

As indicated above, FIG. 4 is provided as an example. Other examples may differ from what is described with regard to FIG. 4.

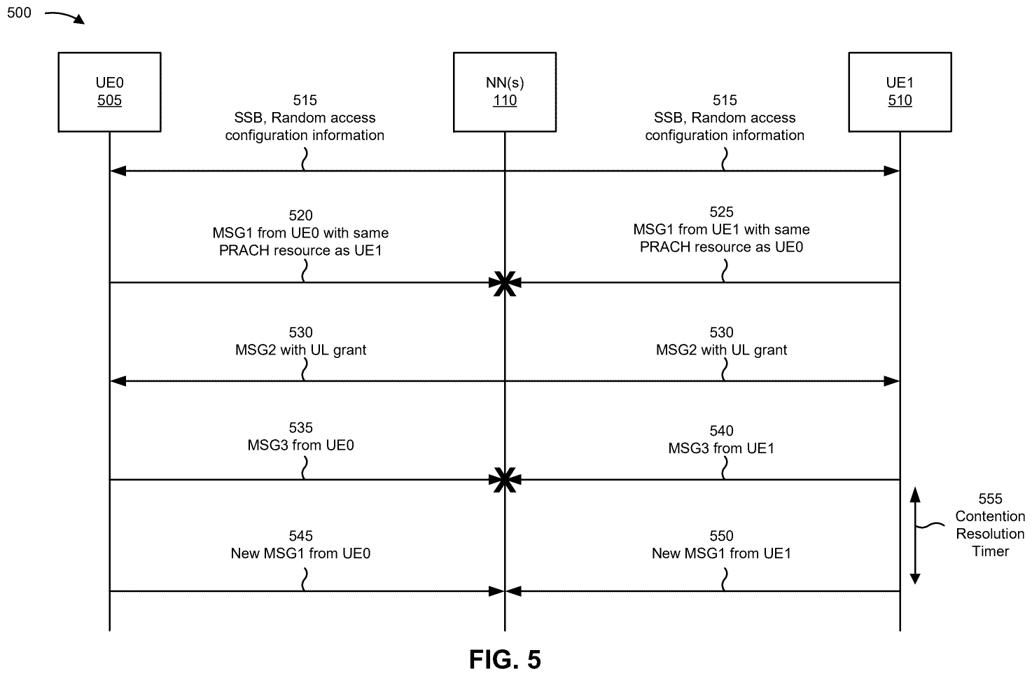

FIG. 5 is a diagram illustrating an example 500 of PRACH collision and MSG3 collision in a four-step, contention-based RACH procedure, in accordance with the present disclosure.

As shown by reference number 515, a network node 110 transmits an SSB and random access configuration information that is received by a UE0 505 and a UE1 510. In some aspects, the SSB and random access configuration information may include a set of preamble sequences that each UE 505 and 510 may use to establish or re-establish a connection with the network node.

As shown by reference number 520, the UE0 505 may select a PRACH resource (e.g., a preamble sequence and an RO) and transmit a MSG1 to the network node 110 using the selected PRACH resource. Additionally, and as shown by reference number 525, the UE1 510 may select the same PRACH resource that is selected by UE0 505 and transmit a MSG1 to the network node 110 using the same PRACH resource that is used by the UE0 505. The network node 110 may receive the MSG1 from the UE0 505 and the MSG1 from the UE1 510, and the network node 110 may consider that a single UE has been detected because each MSG1 uses the same PRACH resource. For example, the network node 110 may generally utilize the PRACH resource information transmitted from multiple UEs to distinguish between the multiple UEs. However, where both UEs 505 and 510 transmit MSG1 using the same PRACH resource, the network node 110 may be unable to distinguish between the UEs.

As shown by reference number 530, the network node 110 may transmit a MSG2 (e.g., an RAR) that is received by both the UE0 505 and the UE1 510. Because the network node 110 considers that only a single UE has been detected, the MSG2 may include a single UL grant that is received by both the UE0 505 and the UE1 510. For example, each UE 505 and 510 may receive a MSG2 that includes a CRC that is scrambled by an RA-RNTI associated with the RO in which the MSG1s of each UE 505 and 510 were transmitted and includes a RAPID corresponding to the preamble sequence used in each MSG1. Additionally, each UE 505 and 510 that transmitted a MSG1 monitors for a MSG2 having a CRC scrambled by the RA-RNTI associated with the RO in which the respective MSG1 was transmitted and a RAPID corresponding to the preamble sequence used in the respective MSG1. Accordingly, when both UE0 505 and UE1 510 receive a MSG2 having a CRC scrambled by the RA-RNTI associated with the RO and a RAPID corresponding to the preamble sequence used in the MSG1 of both the UE0 505 and the UE1 510, each of the UEs 505 and 510 determines that the MSG2 is addressed to itself.

As shown by reference number 535, the UE0 505 may transmit a MSG3 to the network node 110 using the UL grant received in the MSG2 transmitted from the network node 110. As shown by reference number 540, the UE1 510 may also transmit a MSG3 to the network node 110 using the UL grant received in the MSG2 transmitted from the network node 110, where the UL grant is the same as the UL grant received by the UE0 505. As a result, a MSG3 collision may occur where the network node 110 receives a MSG3 from both the UE0 505 and the UE1 510, using the same UL grant.

In such an example, the MSG3 collision may then require a contention resolution process to enable the network node 110 to distinguish between the UE0 505 and the UE1 510. For example, as part of the contention resolution process, the UE0 505 and/or the UE1 510 may retransmit a MSG1 to the network node 110 where the UE0 505 and/or the UE 510 has not received a MSG4 from the network node 110 after the expiration of a contention resolution timer. The contention resolution timer may, for example, be initiated based on the time at which a MSG3 is transmitted from a UE to the network node 110.

As shown in reference number 545, the UE0 505 may transmit a new MSG1 to the network node 110 after failing to receive a MSG4 from the network node 110 after the expiration of the contention resolution timer 555. As shown in reference number 550, the UE1 510 may transmit a new MSG1 to the network node 110 after failing to receive a MSG4 from the network node 110 after the expiration of the contention resolution timer 555.

In some other examples (not explicitly shown in FIG. 5), the network node 110 may decode a single MSG3 received from either the UE0 505 or the UE1 510 and transmit a MSG4 to the UE of the decoded MSG3. The other UE (e.g., the UE associated with an undecoded MSG3) may receive a MSG4 that includes a UE identifier that does not match the other UE, and accordingly, the other UE may wait until the expiration of a contention resolution timer and then re-transmit the MSG3 to the network node 110.

As described herein, where two UEs select the same PRACH resource from a pool of PRACH resources (e.g., ROs and preambles) shared between the two UEs, the UEs may subsequently experience contention between their transmissions to a network node 110. As a result, at least one of the UEs may need to restart the RACH procedure by transmitting a new MSG1 to the network node 110, resulting in a delayed, inefficient process of establishing or re-establishing a connection to the network node.

As indicated above, FIG. 5 is provided as an example. Other examples may differ from what is described with respect to FIG. 5.

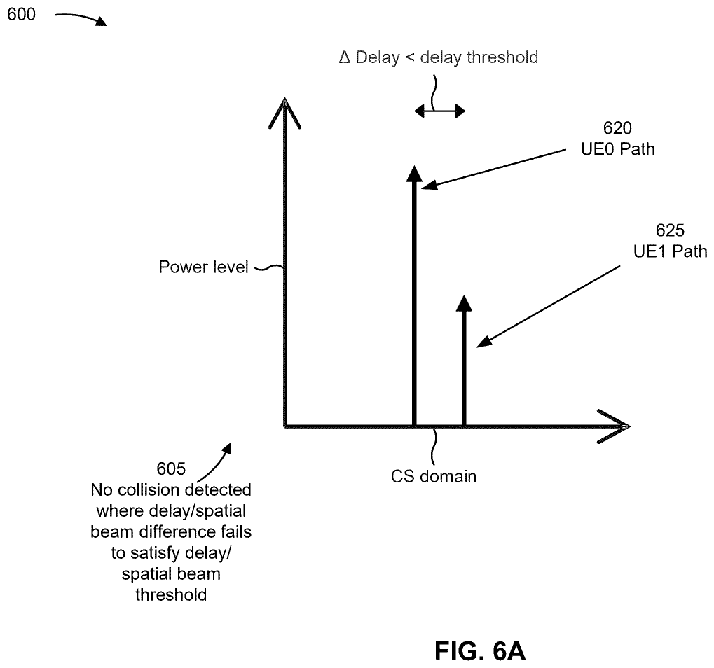

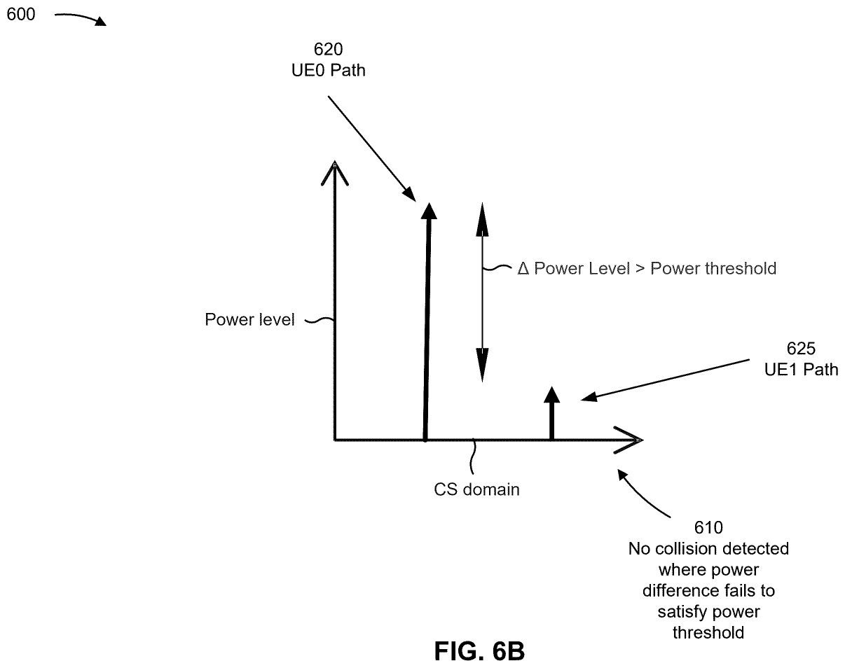

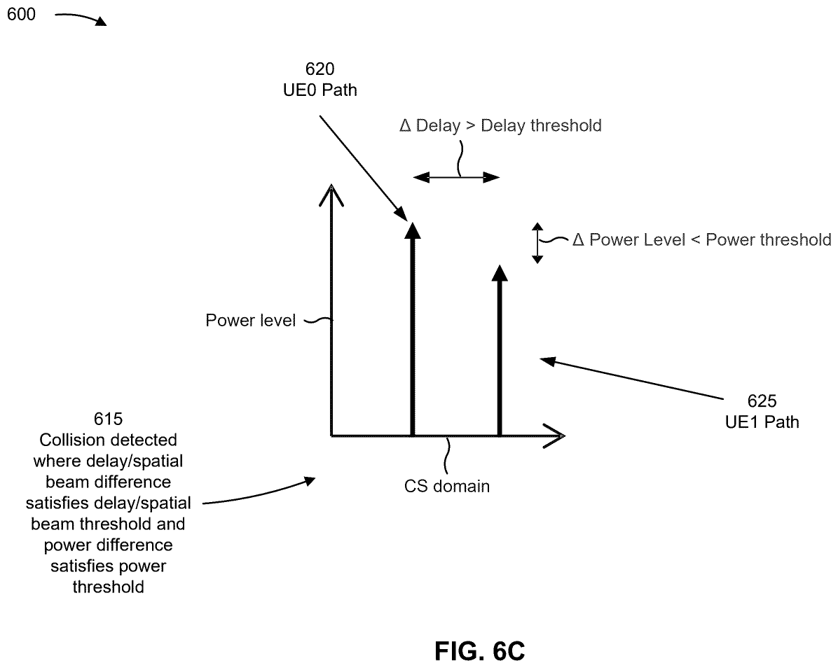

FIGS. 6A-6C are diagrams illustrating examples 600 associated with detection of PRACH collision, in accordance with the present disclosure.

As described herein, a network node may detect a PRACH collision between two UEs (e.g., a UE0 and a UE1), where each UE transmits a MSG1 using the same PRACH resource (e.g., the same preamble sequence and RO). The network node may detect the collision based on multiple received paths in a delay domain (e.g., in a cyclic shift (CS) domain, in a time domain, or the like) and/or a spatial domain (e.g., a spatial direction). In some aspects, the network node may assume that a PRACH collision has occurred if the network node detects two (or more) paths with a delay difference (e.g., a difference between received paths in a CS domain, in a time domain, or the like) and/or a spatial beam difference (e.g, a difference between received paths in a spatial domain, not explicitly shown in FIGS. 6A-6C) that satisfies (e.g., is greater than) a first threshold and a power difference that satisfies (e.g., is less than) a second threshold. Additionally, the delay threshold and/or the power threshold may be configurable by the network node based on, for example, network conditions, potential UE device types, and/or other parameters. In some aspects, the first threshold values and/or the second threshold values may be fixed values or may be otherwise defined in a wireless communication standard.

For example, FIG. 6A illustrates an example configuration for determining whether a PRACH collision has occurred between a UE0 and a UE1. In some aspects, a network node may detect the power level difference and the delay difference (e.g., CS domain) or the spatial beam difference (e.g., in a spatial domain, not explicitly shown in FIGS. 6A-6C) for a UE0 path 620 of a first MSG1 and a UE1 path 625 of a second MSG1 received at the network node. For example, as shown by reference number 605, no collision may be detected where the delay or spatial beam difference fails to satisfy (e.g., is less than) the first threshold (e.g., regardless of whether the power level difference satisfies or fails to satisfy the second threshold).

Additionally, FIG. 6B illustrates an example configuration for determining whether a PRACH collision has occurred between a UE0 and a UE1. In some aspects, a network node may detect the power level and the delay difference or spatial beam difference for a UE path 620 of a first MSG1 and a UE1 path 625 of a second MSG1 received at the network node.

For example, as shown by reference number 610, the received UE0 path 620 and the received UE1 path 625 may each be associated with a respective power level. The network node may be configured with a second threshold (e.g., a power level threshold) for detecting whether a collision has occurred between the UE0 path 620 and the UE1 path 625. For example, the second threshold may be satisfied (and a collision may be detected) where the difference between the power level of the received UE0 path 620 and the power level of the received UE1 path 625 is less than the second threshold (e.g., a power level threshold). Additionally, for example, the second threshold may not be satisfied (and no collision may be detected) where the difference between the power level of the received UE0 path 620 and the power level of the received UE1 path 625 is greater than the second threshold (e.g., a power level threshold). As shown by reference number 610, no collision may be detected between the received UE0 path 620 and the received UE1 path 625 where the power level difference fails to satisfy (e.g., is greater than) the second threshold (e.g., regardless of whether the delay or spatial beam difference satisfies or fails to satisfy the first threshold).

Additionally, FIG. 6C illustrates an example configuration for determining whether a PRACH collision has occurred between a UE0 and a UE1. In some aspects, a network node may detect the power level and the delay difference or spatial beam difference for a UE path 620 of a first MSG1 and a UE1 path 625 of a second MSG1 received at the network node. For example, as shown by reference number 615, a PRACH collision may be detected between the received UE0 path 620 and the received UE1 path 625 where the delay difference satisfies (e.g., is greater than) a delay threshold and the power level difference satisfies (e.g., is less than) a power threshold. By detecting a PRACH collision at the receipt of MSG1s from multiple UEs, the network node may take steps to enable differentiation between the UEs during the RACH procedure. This approach may avoid the network traffic that results from a contention resolution procedure, and may conserve power by preventing unnecessary UE and/or network node transmissions.

As indicated above, FIG. 6 is provided as an example. Other examples may differ from what is described with respect to FIG. 6.

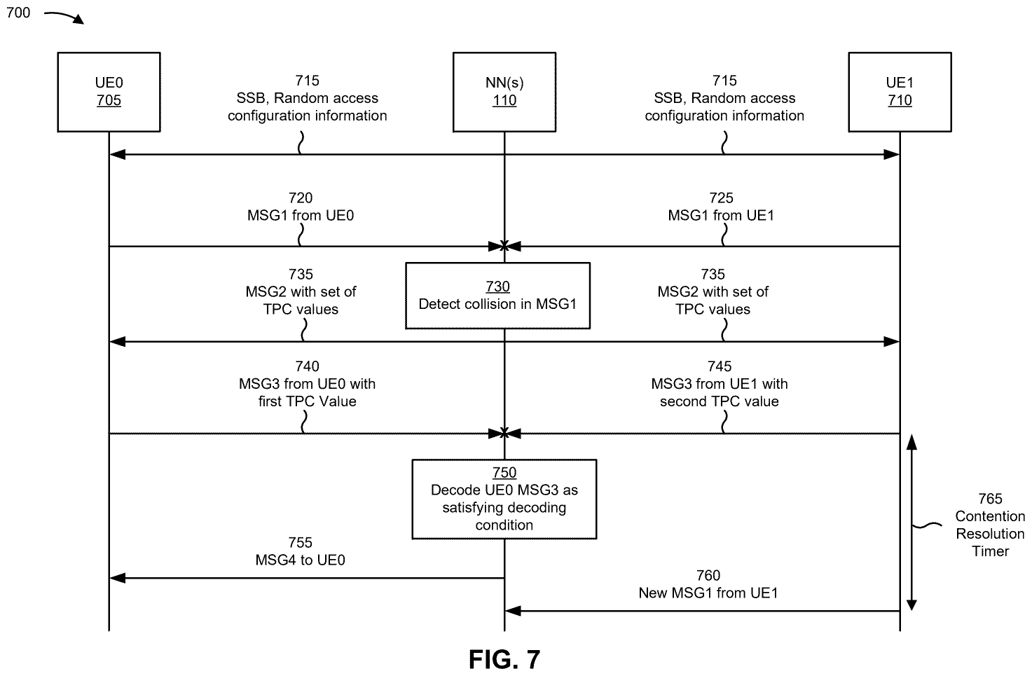

FIG. 7 is a diagram illustrating an example 700 associated with RACH collision handling through multiple TPC commands, in accordance with the present disclosure. As shown in FIG. 7, example 700 includes communication between a network node 110 and a UE0 705 and between the network node 110 and a UE1 710. In some aspects, the network node 110, the UE0 705, and the UE1 710 may be included in a wireless network, such as wireless network 100. The network node 110, the UE0 705, and the UE1 710 may communicate via a wireless access link, which may include an uplink and a downlink.

As shown by reference number 715, the network node 110 may transmit, and the UE0 705 and UE1 710 may each receive, one or more SSBs and random access configuration information. In some aspects, the random access configuration may be transmitted in and/or indicated by system information (e.g., in one or more SIBs) and/or an SSB. The random access configuration information may include one or more parameters to be used in the RACH procedure, such as one or more parameters for transmitting a random access message (e.g., a PRACH message). For example, the random access configuration may indicate PRACH resources (e.g., preambles and ROs) for MSG1 transmissions to the network node 110.

As shown by reference number 720, the UE0 705 may transmit, to the network node 110, a MSG1 (e.g., a PRACH message) in an RO and including a preamble sequence, where the RO and preamble sequence are selected from the PRACH parameters provided by the network node 110. Additionally, and as shown by reference number 725, the UE1 710 may transmit, to the network node 110, a MSG1 (e.g., a PRACH message) in an RO and including a preamble sequence, where the selected RO and preamble sequence are selected from the PRACH parameters provided by the network node 110 and match those selected by the UE0 705. In some aspects, the RO and the preamble sequence may be randomly selected from the parameters provided by the network node 110.

As shown by reference number 730, the network node 110 may detect a PRACH collision between the MSG1 of the UE0 705 and the MSG1 of the UE1 710. In some aspects, the network node 110 may detect a PRACH collision where transmit parameters for two or more UEs satisfy a collision condition. For example, as described herein, the network node 110 may detect differences in power levels between a UE0 path and a UE1 path and/or differences in a delay or spatial beam direction between a UE0 path and a UE1 path. Where one or more of the differences satisfy a threshold, the network node 110 may determine that a PRACH collision has occurred. For example, when the network node 110 received multiple MSG1s with the same preamble, a delay or spatial beam difference (e.g., a difference between the delay (e.g., a delay in a time or a CS domain) or spatial beam (e.g., a spatial direction) of one message from one UE and the delay (e.g., delay in a time or a CS domain) or spatial beam (e.g., spatial direction) of another message from another UE) that satisfies a first threshold, and a power difference (e.g., a difference between the received power (e.g., an RSRP value) of one message from one UE and the received power (e.g., an RSRP value) of another message from another UE) that satisfies a second threshold, the network node 110 may determine that a PRACH collision has occurred. As a result of detecting a PRACH collision, the network node may configure a set of TPC values to be selected by each UE 705 and 710 for use in transmitting a MSG3 (e.g., a PUSCH message) to the network node 110.

As shown by reference number 735, when the network node 110 detects a PRACH collision, the network node may transmit a MSG2 (e.g., an RAR) indicating the set of TPC values. As further shown by reference number 735, the MSG2 indicating the set of TPC values may be received by the UE0 705 and the UE1 710.

In some aspects, the TPC values in the set of TPC values may be configured such that any two TPC values may differ by at least a threshold value. For example, the threshold value may be configured based on the power difference between the MSG1 paths received from multiple UEs (e.g., between UE0 705 and UE1 710).

In some aspects, the network node 110 may transmit an indication of a reference TPC value and an offset and/or range for the set of TPC values, relative to the reference TPC value. Each UE 705 and 710 may determine the set of TPC values according to the reference TPC value and the offset and/or range relative to the reference TPC value. By providing an indication of the reference TPC value and the offset and/or range, the network node 110 may reduce the MSG2 signaling overhead relative to a MSG2 including a complete set of TPC values. In some aspects, the offset and/or range may include random values.

As shown by reference number 740, the UE0 705 may transmit, to the network node 110, a MSG3 (e.g., a PUSCH message) with a first TPC value selected from the set of TPC values received from the network node 110. As shown by reference number 745, the UE1 710 may transmit, to the network node 110, a MSG3 (e.g., a PUSCH message) with a second TPC value selected from the set of TPC values received from the network node 110. In some aspects, the first TPC value may differ from the second TPC value by at least a threshold difference, thus enabling the network node 110 to readily distinguish between the MSG3 transmissions of the UE0 705 and the UE1 710.

As shown by reference number 750, the network node 110 may decode the received MSG3 (e.g., the MSG3 transmitted from UE0 705) that satisfies a decoding condition. In some aspects, the condition may be satisfied where the TPC value associated with a received MSG3 satisfies a power level threshold. In some aspects, the network node 110 may decode the received MSG3 that is associated with the highest received power level.

As shown by reference number 755, where the network node 110 has decoded the MSG3 received from the UE0 705, the network node 110 may then transmit a MSG4 to the UE0 705. In some aspects, for example, the MSG4 may include information that confirms the identity of the UE0 705 and provides the UE0 705 with a C-RNTI. Additionally, because the UE1 710 did not satisfy the condition for decoding, the network node 110 does not decode the MSG3 received from the UE1 710. In some other aspects, for example, the network node 110 may not decode the UE1 710 where the TPC value associated with the MSG3 of the UE1 710 is not associated with the highest power level received by the network node 110.

As shown by reference number 760, for the UE1 710 with an undecoded MSG3, the UE1 710 may transmit a new MSG1 after the expiration of a contention resolution timer 765. In some aspects, the UE1 710 may transmit the new MSG1 with an increased power level relative to the power level of a previously-transmitted MSG1. In some other aspects, the UE1 710 may transmit a new MSG1 in response to receiving a MSG4 from the network node 110 that contains a UE identifier that does not match the identification of the UE1 710.

As described herein, when multiple UEs transmit a MSG1 (e.g., a PRACH message) using the same PRACH resource at the same time, the resulting PRACH collision may require a contention resolution procedure to establish or re-establish a connection with a network node. Additionally, or alternatively, a PRACH collision may require each UE to restart the RACH procedure to establish or re-establish a connection with the network node. Accordingly, enabling a network node to detect a potential PRACH collision (e.g., detecting a collision upon receipt of MSG1 transmissions from two or more UEs) and to preemptively provide the UEs with a set of TPC values May simplify the RACH procedure and improve the efficiency of the RACH procedure by avoiding a legacy contention resolution process.

As indicated above, FIG. 7 is provided as an example. Other examples may differ from what is described with respect to FIG. 7.

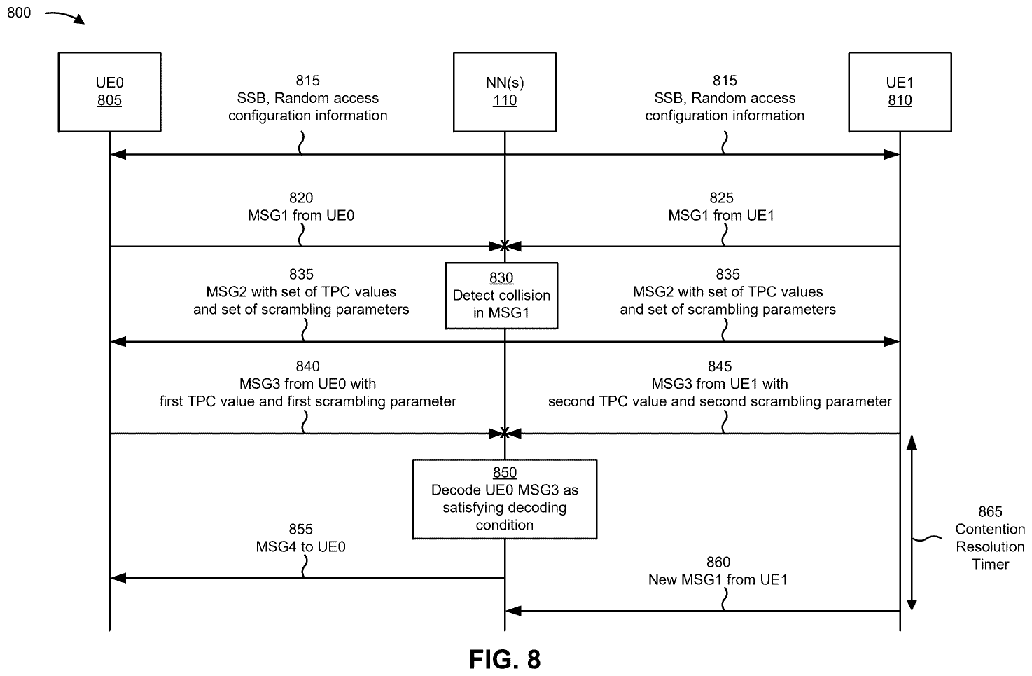

FIG. 8 is a diagram illustrating an example 800 associated with RACH collision handling through multiple TPC commands, in accordance with the present disclosure.

As shown by reference number 815, the network node 110 may transmit, and the UE0 805 and UE1 810 may each receive, one or more SSBs and random access configuration information. In some aspects, the random access configuration may be transmitted in and/or indicated by system information (e.g., in one or more SIBs) and/or an SSB. The random access configuration information may include one or more parameters to be used in the RACH procedure, such as one or more parameters for transmitting a random access message (e.g., a PRACH message). For example, the random access configuration may indicate PRACH resources (e.g., preambles and ROs) for MSG1 transmissions to the network node 110.

As shown by reference number 820, the UE0 805 may transmit, to the network node 110, a MSG1 (e.g., a PRACH message) in an RO and including a preamble sequence, where the RO and preamble sequence are selected from the PRACH parameters provided by the network node 110. Additionally, and as shown by reference number 825, the UE1 810 may transmit, to the network node 110, a MSG1 (e.g., a PRACH message) in an RO and including a preamble sequence, where the selected RO and preamble sequence match those selected by the UE0 805. In some aspects, the RO and the preamble sequence may be randomly selected from the PRACH parameters provided by the network node.

As shown by reference number 830, the network node 110 may detect a PRACH collision between the MSG1 of the UE0 805 and the MSG1 of the UE1 810. In some aspects, the network node 110 may detect a PRACH collision where transmit parameters for two or more UEs satisfy a collision condition. For example, as described herein, the network node 110 may detect differences in power levels between a UE0 path and a UE1 path and/or differences in a delay or spatial beam direction between a UE0 path and a UE1 path. Where one or more of the differences satisfy a threshold, the network node 110 may determine that a PRACH collision has occurred. For example, when the network node 110 received multiple MSG1s with the same preamble, a delay or spatial beam difference that satisfies a first threshold, and a power difference that satisfies a second threshold, the network node 110 may determine that a PRACH collision has occurred. As a result, the network node may configure a set of TPC values and a set of scrambling parameters to be selected by each UE 805 and 810 for transmission of a MSG3 (e.g., a PUSCH message) to the network node 110.

As shown by reference number 835, when the network node 110 has detected a PRACH collision, the network node 110 may transmit a MSG2 (e.g., an RAR) indicating the set of TPC values and the set of scrambling parameters. As further shown by reference number 835, the MSG2 indicating the set of TPC values and the set of scrambling parameters may be received by the UE0 805 and the UE1 815, where the MSG2 includes the set of TPC values and the set of scrambling parameters. In some aspects, the scrambling parameters may be DMRS scrambling parameters, and/or the scrambling parameters may include DMRS scrambling identifiers (IDs). In some aspects, each scrambling parameter corresponds to a different TPC value that is indicated in the MSG2. Alternatively, the network node may configure each of UE 805 and 810 to randomly and/or separately select a TPC value and a random scrambling parameter.

As shown by reference number 840, the UE0 805 may transmit, to the network node 110, a MSG3 (e.g., a PUSCH message) with a first TPC value and a first scrambling parameter respectively selected from the set of TPC values and the set of scrambling parameters received from the network node 110. As shown by reference number 845, the UE1 810 may transmit, to the network node 110, a MSG3 (e.g., a PUSCH message) with a second TPC value and a second scrambling parameter selected from the set of TPC values and the set of scrambling parameters received from the network node 110. In some aspects, the network node may configure the UE0 805 and/or the UE1 810 to randomly and/or separately select the TPC value and the scrambling parameter used for transmitting the MSG3. Alternatively, in some aspects, the network node 110 may assign the scrambling parameter for each TPC value. For example, by assigning the scrambling parameter for each TPC value, the network node 110 may simplify the blind decoding process at the network node 110, where the network node 110 may start decoding the scrambling parameter associated with the highest received power level, followed by the scrambling parameter associated with the next highest received power level, and so on.

As shown by reference number 850, the network node 110 may decode the received MSG3 (e.g., the MSG 3 transmitted from UE0 805) that satisfies a decoding condition. In some aspects, the condition may be satisfied where the TPC value satisfies a power level threshold. In some aspects, the network node 110 may decode the received MSG3 that is associated with the highest received power level. For example, because different scrambling parameters may be used for different MSG3 transmissions, the network node 110 may perform blind decoding based on each potential scrambling parameter for the MSG3 transmission with the highest received power level. In some aspects, after the network node 110 has decoded a first MSG3 associated with a highest power level, the network node 110 may perform SIC to cancel the impact of the first MSG3 and may proceed with decoding the MSG3 associated with a lower received power level. By performing SIC on the UE associated with the decoded MSG3, the network node 110 may reduce network congestion and conserve processing power associated with detecting and processing UE transmissions where the network node may detect multiple MSG3s and thus avoid requiring one or more other UEs to retransmit MSG1.

As shown by reference number 855, where the network node 110 has decoded the MSG3 received from the UE0 805, the network node 110 may then transmit a MSG4 to the UE0 805. In some aspects, for example, the MSG4 may include information that confirms the identity of the UE0 805 and provides the UE0 805 with a C-RNTI. Additionally, because the UE1 810 did not satisfy the decoding condition, the network node 110 does not decode the MSG3 received from the UE1 810. In some other aspects, for example, the network node may not decode the UE1 810 where the TPC value associated with the MSG3 of UE1 810 is not the highest TPC value received by the network node 110.

As shown by reference number 860, as the UE with an undecoded MSG3, the UE1 810 may transmit a new MSG1 after the expiration of a contention resolution timer 865. In some aspects, the UE1 810 may transmit the new MSG1 with an increased power level relative to the power level of a previously-transmitted MSG1. In some other aspects, the UE1 810 may transmit a new MSG1 in response to receiving a MSG3 from the network node 110 that contains a UE identifier that does not match the identifier of the UE1 810.

As described herein, when multiple UEs transmit using the same PRACH resource at the same time, the resulting PRACH collision may require a contention resolution procedure to remedy the PRACH collision and establish or re-establish a connection with a network node. Accordingly, enabling a network node to detect a potential PRACH collision and to preemptively provide the UEs with a set of TPC values and a set of scrambling parameters may simplify the RACH procedure and improve the efficiency of the RACH procedure. Additionally, by utilizing both a set of TPC values and a set of scrambling parameters, the network node may be able to distinguish between UEs according to both power levels and scrambling parameters. For example, this approach provides additional accuracy to the process of identifying UEs involved in a PRACH collision and improves the efficiency of decoding MSG3s received at the network node (e.g., by enabling the network node to perform SIC to cancel the impact of decoded MSG3s and thereby decode additional MSG3s without the need for UEs to potentially retransmit a MSG1 and restart the RACH procedure).

As indicated above, FIG. 8 is provided as an example. Other examples may differ from what is described with respect to FIG. 8.

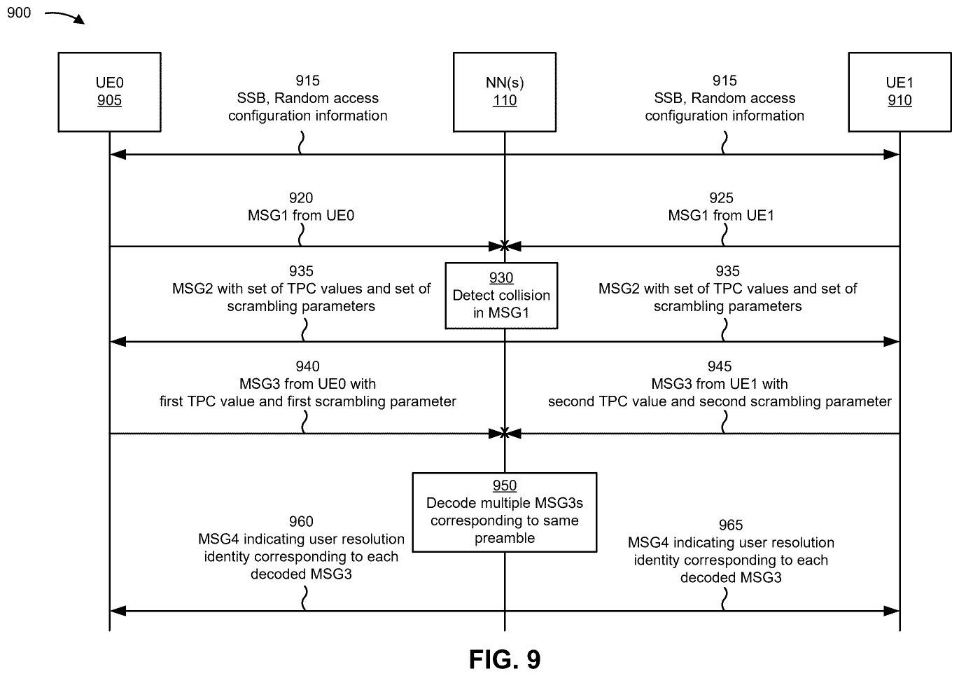

FIG. 9 is a diagram illustrating an example 900 associated with RACH collision handling through multiple TPC commands, in accordance with the present disclosure.

As shown by reference number 915, the network node 110 may transmit, and the UE0 905 and UE1 910 may each receive, one or more SSBs and random access configuration information. In some aspects, the random access configuration may be transmitted in and/or indicated by system information (e.g., in one or more SIBs) and/or an SSB. The random access configuration information may include one or more PRACH parameters to be used in the RACH procedure, such as one or more PRACH parameters for transmitting a random access message (e.g., a PRACH message). For example, the random access configuration may indicate separate PRACH resources (e.g., preambles and ROs) for MSG1 transmissions to the network node 110.

As shown by reference number 920, the UE0 905 may transmit, to the network node 110, a MSG1 (e.g., a PRACH message) in an RO and including a preamble sequence, where the RO and preamble sequence are selected from the PRACH parameters provided by the network node 110. Additionally, and as shown by reference number 925, the UE1 910 may transmit, to the network node 110, a MSG1 (e.g., a PRACH message) in an RO and including a preamble sequence, where the selected RO and preamble sequence match those selected by the UE0 905. In some aspects, the RO and the preamble sequence may be randomly selected from the parameters provided by the network node.

As shown by reference number 930, the network node 110 may detect a PRACH collision between the MSG1 of the UE0 905 and the MSG1 of the UE1 910. In some aspects, the network node 110 may detect a PRACH collision where transmit parameters for two or more UEs satisfy a collision condition. As a result, the network node may configure a set of TPC values and scrambling parameters to be selected by each UE 905 and 910 for transmission of a MSG3 (e.g., a PUSCH message) to the network node 110.

As shown by reference number 935, when the network node 110 has detected a PRACH collision, the network node may transmit a MSG2 (e.g., an RAR) that is received by the UE0 905 and the UE1 915, where the MSG2 includes the set of TPC values and scrambling parameters.

As shown by reference number 940, the UE0 905 may transmit, to the network node 110, a MSG3 (e.g., a PUSCH message) with a first TPC value selected from the set of TPC values and a first scrambling parameter selected from the set of scrambling parameters. As shown by reference number 945, the UE1 910 may transmit, to the network node 110, a MSG3 (e.g., a PUSCH message) with a second TPC value selected from the set of TPC values and a second scrambling parameter selected from the set of scrambling parameters. In some aspects, the UE0 905 and/or the UE1 910 may randomly and/or separately select the TPC value and the scrambling parameter used for transmitting the MSG3.

As shown by reference number 950, the network node 110 may decode multiple received MSG3s that correspond to, for example, the same preamble sequence. As a result, the network node 110 may configure MSG4 transmissions that include a MAC-CE. As shown by reference number 960 and reference number 965, the network node may transmit the MAC-CE including multiple user resolution identities, where each user resolution identity corresponds to one decoded MSG3 transmission from a UE. In some aspects, for each UE (e.g. UE0 905 and UE1 910) with a decoded MSG3, the network node 110 may allocate a new C-RNTI, where the previously-allocated temporary C-RNTI (TC-RNTI) may have been allocated to multiple users and is thus unable to be used as a C-RNTI for any UE. By providing the multiple user resolution identities in the MAC-CE associated with the MSG4, the network node may utilize the included user resolution identities and the new C-RNTI to distinguish between the UEs 905 and 910 and thus simplify the RACH procedure and avoid and/or reduce the relatively lengthy process of contention resolution.

Additionally, in some aspects, the MSG4 may include a secondary TPC configuration for each UE associated with a successfully decoded MSG3, where the secondary TPC configuration may be used in one or more transmissions subsequent to the MSG3 (e.g., the PUSCH message) transmitted by the UE. In some aspects, the secondary TPC configuration may be used to revert the TPC value that was used in the MSG3 transmissions by each UE. In some aspects, the secondary TPC configuration may be optional where each UE may be configured to adjust the TPC from the TPC value used in the MSG3 transmission by the UE.

As indicated above, FIG. 9 is provided as an example. Other examples may differ from what is described with respect to FIG. 9.

FIG. 10 is a diagram illustrating an example process 1000 performed, for example, at a UE or an apparatus of a UE, in accordance with the present disclosure. Example process 1000 is an example where the apparatus or the UE (e.g., UE 120) performs operations associated with RACH collision handling through multiple TPC commands.

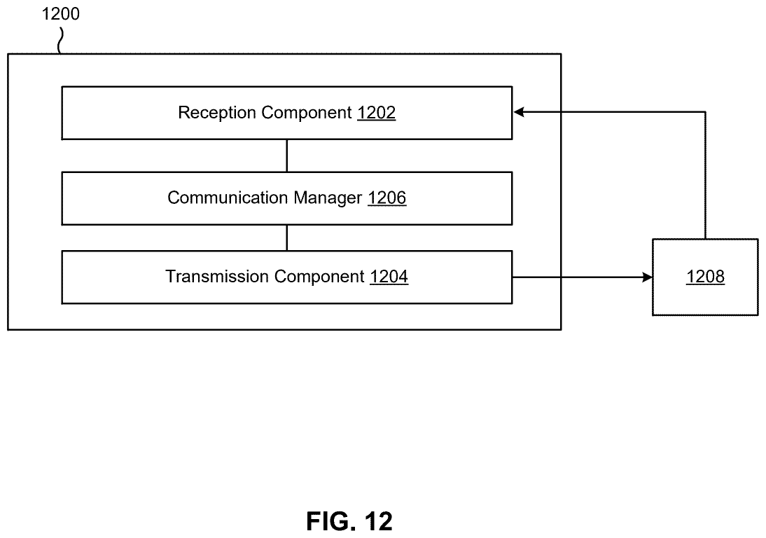

As shown in FIG. 10, in some aspects, process 1000 may include transmitting, to a network node, a PRACH message (block 1010). For example, the UE (e.g., using transmission component 1204 and/or communication manager 1206, depicted in FIG. 12) may transmit, to a network node, a PRACH message, as described above.

As further shown in FIG. 10, in some aspects, process 1000 may include receiving, from the network node, an RAR indicating a set of TPC values (block 1020). For example, the UE (e.g., using reception component 1202 and/or communication manager 1206, depicted in FIG. 12) may receive, from the network node, an RAR indicating a set of TPC values, as described above.

As further shown in FIG. 10, in some aspects, process 1000 may include transmitting, to the network node, a PUSCH message using a TPC value selected from the set of TPC values (block 1030). For example, the UE (e.g., using transmission component 1204 and/or communication manager 1206, depicted in FIG. 12) may transmit, to the network node, a PUSCH message using a TPC value selected from the set of TPC values, as described above.

Process 1000 may include additional aspects, such as any single aspect or any combination of aspects described below and/or in connection with one or more other processes described elsewhere herein.

In a first aspect, each TPC value in the set of TPC values differs from every other TPC value in the set of TPC values by at least a threshold difference.

In a second aspect, alone or in combination with the first aspect, the RAR indicates the set of TPC values according to a reference TPC value and at least one of a range or an offset relative to the reference TPC value.

In a third aspect, alone or in combination with one or more of the first and second aspects, the RAR indicates a set of DMRS scrambling parameters that are each associated with a TPC value in the set of TPC values.

In a fourth aspect, alone or in combination with one or more of the first through third aspects, the PUSCH message includes a DMRS that is associated with a DMRS scrambling parameter in the set of DMRS scrambling parameters.

In a fifth aspect, alone or in combination with one or more of the first through fourth aspects, the RAR indicates a set of DMRS scrambling parameters and the PUSCH message includes a DMRS associated with a DMRS scrambling parameter selected from the set of DMRS scrambling parameters.

In a sixth aspect, alone or in combination with one or more of the first through fifth aspects, the TPC value is randomly selected from the set of TPC values and the DMRS scrambling parameter is randomly selected from the set of DMRS scrambling parameters.

In a seventh aspect, alone or in combination with one or more of the first through sixth aspects, the TPC value and the DMRS scrambling parameter are selected independently of one another.

In an eighth aspect, alone or in combination with one or more of the first through seventh aspects, the PRACH message is transmitted in a random access channel (RACH) occasion and includes a preamble sequence.

In a ninth aspect, alone or in combination with one or more of the first through eighth aspects, process 1000 includes receiving, from the network node, a MAC-CE that includes a user resolution identity associated with the PUSCH message.

In a tenth aspect, alone or in combination with one or more of the first through ninth aspects, process 1000 includes receiving, from the network node, a secondary TPC configuration for use in one or more transmissions subsequent to the PUSCH message.

In an eleventh aspect, alone or in combination with one or more of the first through tenth aspects, process 1000 includes retransmitting, to the network node, the PRACH message at an increased power level in accordance with not receiving a contention resolution message prior to an expiration of a contention resolution timer.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with RACH collision handling through multiple TPC commands.

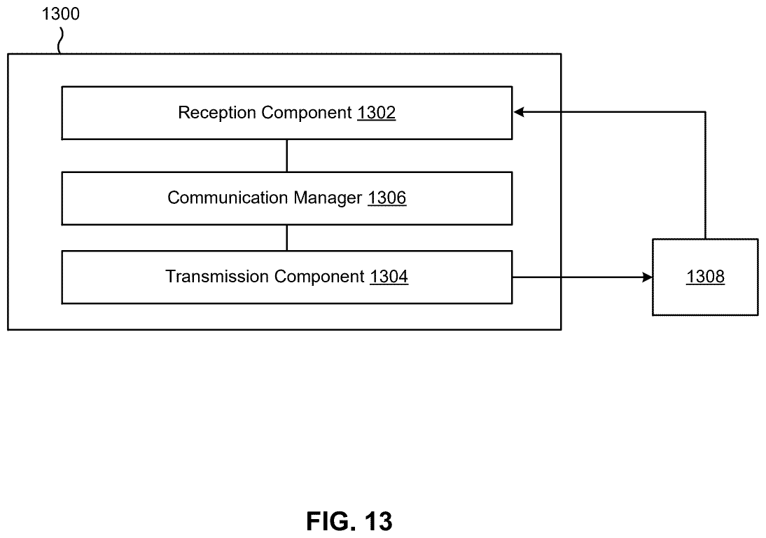

As shown in FIG. 11, in some aspects, process 1100 may include receiving a first PRACH message associated with a PRACH resource and a second PRACH message associated with the PRACH resource (block 1110). For example, the network node (e.g., using reception component 1302 and/or communication manager 1306, depicted in FIG. 13) may receive a first PRACH message associated with a PRACH resource and a second PRACH message associated with the PRACH resource, as described above.

As further shown in FIG. 11, in some aspects, process 1100 may include transmitting, in response to the first PRACH message and the second PRACH message, an RAR indicating a set of TPC values (block 1120). For example, the network node (e.g., using transmission component 1304 and/or communication manager 1306, depicted in FIG. 13) may transmit, in response to the first PRACH message and the second PRACH message, an RAR indicating a set of TPC values, as described above.

As further shown in FIG. 11, in some aspects, process 1100 may include receiving a first PUSCH message and a second PUSCH message, wherein the first PUSCH message and the second PUSCH message are associated with different TPC values from the set of TPC values (block 1130). For example, the network node (e.g., using reception component 1302 and/or communication manager 1306, depicted in FIG. 13) may receive a first PUSCH message and a second PUSCH message, wherein the first PUSCH message and the second PUSCH message are associated with different TPC values from the set of TPC values, as described above.

Process 1100 may include additional aspects, such as any single aspect or any combination of aspects described below and/or in connection with one or more other processes described elsewhere herein.

In a first aspect, each TPC value in the set of TPC values differs from every other TPC value in the set of TPC values by at least a threshold difference.

In a second aspect, alone or in combination with the first aspect, each of the first PUSCH message and the second PUSCH message includes a DMRS associated with a different DMRS scrambling parameter.

In a third aspect, alone or in combination with one or more of the first and second aspects, process 1100 includes detecting a PRACH collision between the first PRACH message and the second PRACH message based on a difference between a delay of the first PRACH message and a delay of the second PRACH message satisfying a first threshold and a difference between a received power of the first PRACH message and a received power of the second PRACH message satisfying a second threshold.

In a fourth aspect, alone or in combination with one or more of the first through third aspects, process 1100 includes detecting a PRACH collision between the first PRACH message and the second PRACH message based on a difference between a spatial beam of the first PRACH message and a spatial beam of the second PRACH message satisfying a first threshold and a difference between a received power of the first PRACH message and a received power of the second PRACH message satisfying a second threshold.

In a fifth aspect, alone or in combination with one or more of the first through fourth aspects, the RAR is associated with a reference TPC value and at least one of a range value or an offset value.

In a sixth aspect, alone or in combination with one or more of the first through fifth aspects, the RAR indicates a set of DMRS scrambling parameters that are each associated with at least one TPC value in the set of TPC values.

In a seventh aspect, alone or in combination with one or more of the first through sixth aspects, at least one of the first PUSCH message or the second PUSCH message includes a DMRS that is associated with a DMRS scrambling parameter selected from the set of DMRS scrambling parameters.

In an eighth aspect, alone or in combination with one or more of the first through seventh aspects, the RAR indicates a set of demodulation reference signal (DMRS) scrambling parameters and at least one of the first PUSCH message or the second PUSCH message includes a DMRS associated with a DMRS scrambling parameter selected from the set of DMRS scrambling parameters.

In a ninth aspect, alone or in combination with one or more of the first through eighth aspects, process 1100 includes decoding one of the first PUSCH message or the second PUSCH message that is associated with a highest power level.

In a tenth aspect, alone or in combination with one or more of the first through ninth aspects, the PRACH message is transmitted in an RO and includes a preamble sequence.

In an eleventh aspect, alone or in combination with one or more of the first through tenth aspects, process 1100 includes transmitting, to a UE, a MAC-CE that includes a user resolution identity associated with the PUSCH message.

In a twelfth aspect, alone or in combination with one or more of the first through eleventh aspects, process 1100 includes transmitting, to a UE, a secondary TPC configuration for use in one or more transmissions subsequent to a transmission of a PUSCH message from the UE to the network node.

In a thirteenth aspect, alone or in combination with one or more of the first through twelfth aspects, process 1100 includes receiving, from a UE, a retransmission of the PRACH message at an increased power level in accordance with the UE not receiving a contention resolution message prior to an expiration of a contention resolution timer.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 6A-6C, FIG. 7, FIG. 8, and/or FIG. 9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit, to a network node, a PRACH message. The reception component 1202 may receive, from the network node, an RAR indicating a set of TPC values. The transmission component 1204 may transmit, to the network node, a PUSCH message using a TPC value selected from the set of TPC values.

The reception component 1202 may receive, from the network node, a MAC-CE that includes a user resolution identity associated with the PUSCH message.

The reception component 1202 may receive, from the network node, a secondary TPC configuration for use in one or more transmissions subsequent to the PUSCH message.

The transmission component 1204 may retransmit, to the network node, the PRACH message at an increased power level in accordance with not receiving a contention resolution message prior to an expiration of a contention resolution timer.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 6A-6C, FIG. 7, FIG. 8, and/or FIG. 9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node described in connection with FIG. 1 and FIG. 2. Additionally, or alternatively, one or more components shown in FIG. 13 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive a first PRACH message associated with a PRACH resource and a second PRACH message associated with the PRACH resource. The transmission component 1304 may transmit, in response to the first PRACH message and the second PRACH message, an RAR indicating a set of TPC values. The reception component 1302 may receive a first PUSCH message and a second PUSCH message, wherein the first PUSCH message and the second PUSCH message are associated with different TPC values from the set of TPC values.

The communication manager 1306 may detect a PRACH collision between the first PRACH message and the second PRACH message based on a difference between a delay of the first PRACH message and a delay of the second PRACH message satisfying a first threshold and a difference between a received power of the first PRACH message and a received power of the second PRACH message satisfying a second threshold.

The communication manager 1306 may detect a PRACH collision between the first PRACH message and the second PRACH message based on a difference between a spatial beam of the first PRACH message and a spatial beam of the second PRACH message satisfying a first threshold and a difference between a received power of the first PRACH message and a received power of the second PRACH message satisfying a second threshold.

The communication manager 1306 may decode one of the first PUSCH message or the second PUSCH message that is associated with a highest power level.

The transmission component 1304 may transmit, to a UE, a MAC-CE that includes a user resolution identity associated with the PUSCH message.

The transmission component 1304 may transmit, to a UE, a secondary TPC configuration for use in one or more transmissions subsequent to a transmission of a PUSCH message from the UE to the network node.

The reception component 1302 may receive, from a UE, a retransmission of the PRACH message at an increased power level in accordance with the UE not receiving a contention resolution message prior to an expiration of a contention resolution timer.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: transmitting, to a network node, a physical random access channel (PRACH) message; receiving, from the network node, a random access response (RAR) indicating a set of transmit power control (TPC) values; and transmitting, to the network node, a physical uplink shared channel (PUSCH) message using a TPC value selected from the set of TPC values.

Aspect 2: The method of Aspect 1, wherein each TPC value in the set of TPC values differs from every other TPC value in the set of TPC values by at least a threshold difference.

Aspect 3: The method of any of Aspects 1-2, wherein the RAR indicates the set of TPC values according to a reference TPC value and at least one of a range or an offset relative to the reference TPC value.

Aspect 4: The method of any of Aspects 1-3, wherein the RAR indicates a set of demodulation reference signal (DMRS) scrambling parameters that are each associated with a TPC value in the set of TPC values.

Aspect 5: The method of Aspect 4, wherein the PUSCH message includes a DMRS that is associated with a DMRS scrambling parameter in the set of DMRS scrambling parameters.

Aspect 6: The method of Aspect 5, wherein the RAR indicates a set of demodulation reference signal (DMRS) scrambling parameters and the PUSCH message includes a DMRS associated with a DMRS scrambling parameter selected from the set of DMRS scrambling parameters.

Aspect 7: The method of Aspect 6, wherein the TPC value is randomly selected from the set of TPC values and the DMRS scrambling parameter is randomly selected from the set of DMRS scrambling parameters.

Aspect 8: The method of Aspect 7, wherein the TPC value and the DMRS scrambling parameter are selected independently of one another.

Aspect 9: The method of any of Aspects 1-8, wherein the PRACH message is transmitted in a random access channel (RACH) occasion and includes a preamble sequence.

Aspect 10: The method of any of Aspects 1-9, further comprising: receiving, from the network node, a medium access control control element (MAC-CE) that includes a user resolution identity associated with the PUSCH message.

Aspect 11: The method of Aspect 10, further comprising: receiving, from the network node, a secondary TPC configuration for use in one or more transmissions subsequent to the PUSCH message.

Aspect 12: The method of any of Aspects 1-11, further comprising: retransmitting, to the network node, the PRACH message at an increased power level in accordance with not receiving a contention resolution message prior to an expiration of a contention resolution timer.

Aspect 13: A method of wireless communication performed by a network node, comprising: receiving a first physical random access channel (PRACH) message associated with a PRACH resource and a second PRACH message associated with the PRACH resource; transmitting, in response to the first PRACH message and the second PRACH message, a random access response (RAR) indicating a set of transmit power control (TPC) values; and receiving a first physical uplink shared channel (PUSCH) message and a second PUSCH message, wherein the first PUSCH message and the second PUSCH message are associated with different TPC values from the set of TPC values.

Aspect 14: The method of Aspect 13, wherein each TPC value in the set of TPC values differs from every other TPC value in the set of TPC values by at least a threshold difference.

Aspect 15: The method of any of Aspects 13-14, wherein each of the first PUSCH message and the second PUSCH message includes a demodulation reference signal (DMRS) associated with a different DMRS scrambling parameter.

Aspect 16: The method of any of Aspects 13-15, further comprising: detecting a PRACH collision between the first PRACH message and the second PRACH message based on a difference between a delay of the first PRACH message and a delay of the second PRACH message satisfying a first threshold and a difference between a received power of the first PRACH message and a received power of the second PRACH message satisfying a second threshold.

Aspect 17: The method of any of Aspects 13-16, further comprising: detecting a PRACH collision between the first PRACH message and the second PRACH message based on a difference between a spatial beam of the first PRACH message and a spatial beam of the second PRACH message satisfying a first threshold and a difference between a received power of the first PRACH message and a received power of the second PRACH message satisfying a second threshold.

Aspect 18: The method of any of Aspects 13-17, wherein the RAR is associated with a reference TPC value and at least one of a range value or an offset value.

Aspect 19: The method of any of Aspects 13-18, wherein the RAR indicates a set of demodulation reference signal (DMRS) scrambling parameters that are each associated with at least one TPC value in the set of TPC values.

Aspect 20: The method of Aspect 19, wherein at least one of the first PUSCH message or the second PUSCH message includes a DMRS that is associated with a DMRS scrambling parameter selected from the set of DMRS scrambling parameters.

Aspect 21: The method of any of Aspects 13-20, wherein the RAR indicates a set of demodulation reference signal (DMRS) scrambling parameters and at least one of the first PUSCH message or the second PUSCH message includes a DMRS associated with a DMRS scrambling parameter selected from the set of DMRS scrambling parameters.

Aspect 22: The method of any of Aspects 13-21, further comprising: decoding one of the first PUSCH message or the second PUSCH message that is associated with a highest power level.

Aspect 23: The method of any of Aspects 13-22, wherein the PRACH message is transmitted in a random access channel (RACH) occasion and includes a preamble sequence.

Aspect 24: The method of any of Aspects 13-23, further comprising: transmitting, to a UE, a medium access control control element (MAC-CE) that includes a user resolution identity associated with the PUSCH message.

Aspect 25: The method of Aspect 24, further comprising: transmitting, to a UE, a secondary TPC configuration for use in one or more transmissions subsequent to a transmission of a PUSCH message from the UE to the network node.

Aspect 26: The method of any of Aspects 13-25, further comprising: receiving, from a UE, a retransmission of the PRACH message at an increased power level in accordance with the UE not receiving a contention resolution message prior to an expiration of a contention resolution timer.

Aspect 27: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-26.

Aspect 28: An apparatus for wireless communication at a device, the apparatus comprising one or more memories and one or more processors coupled to the one or more memories, the one or more processors configured to cause the device to perform the method of one or more of Aspects 1-26.

Aspect 29: An apparatus for wireless communication, the apparatus comprising at least one means for performing the method of one or more of Aspects 1-26.

Aspect 30: A non-transitory computer-readable medium storing code for wireless communication, the code comprising instructions executable by one or more processors to perform the method of one or more of Aspects 1-26.

Aspect 31: A non-transitory computer-readable medium storing a set of instructions for wireless communication, the set of instructions comprising one or more instructions that, when executed by one or more processors of a device, cause the device to perform the method of one or more of Aspects 1-26.

Aspect 32: A device for wireless communication, the device comprising a processing system that includes one or more processors and one or more memories coupled with the one or more processors, the processing system configured to cause the device to perform the method of one or more of Aspects 1-26.

Aspect 33: An apparatus for wireless communication at a device, the apparatus comprising one or more memories and one or more processors coupled to the one or more memories, the one or more processors individually or collectively configured to cause the device to perform the method of one or more of Aspects 1-26.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a +b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
transmit, to a network node, a physical random access channel (PRACH) message;
receive, from the network node, a random access response (RAR) indicating a set of transmit power control (TPC) values; and
transmit, to the network node, a physical uplink shared channel (PUSCH) message using a TPC value selected from the set of TPC values.

2. The UE of claim 1, wherein each TPC value in the set of TPC values differs from every other TPC value in the set of TPC values by at least a threshold difference.

3. The UE of claim 1, wherein the RAR indicates the set of TPC values according to a reference TPC value and at least one of a range or an offset relative to the reference TPC value.

4. The UE of claim 1, wherein the RAR indicates a set of demodulation reference signal (DMRS) scrambling parameters that are each associated with a TPC value in the set of TPC values.

5. The UE of claim 4, wherein the PUSCH message includes a DMRS that is associated with a DMRS scrambling parameter in the set of DMRS scrambling parameters.

6. The UE of claim 5, wherein the RAR indicates a set of demodulation reference signal (DMRS) scrambling parameters and the PUSCH message includes a DMRS associated with a DMRS scrambling parameter selected from the set of DMRS scrambling parameters.

7. The UE of claim 6, wherein the TPC value is randomly selected from the set of TPC values and the DMRS scrambling parameter is randomly selected from the set of DMRS scrambling parameters.

8. The UE of claim 7, wherein the TPC value and the DMRS scrambling parameter are selected independently of one another.

9. The UE of claim 1, wherein the one or more processors are further configured to cause the UE to:
retransmit, to the network node, the PRACH message at an increased power level in accordance with not receiving a contention resolution message prior to an expiration of a contention resolution timer.

10. A network node for wireless communication, comprising:
one or more memories; and
one or more processors, coupled to the one or more memories, configured to cause the network node to:
receive a first physical random access channel (PRACH) message associated with a PRACH resource and a second PRACH message associated with the PRACH resource;
transmit, in response to the first PRACH message and the second PRACH message, a random access response (RAR) indicating a set of transmit power control (TPC) values; and
receive a first physical uplink shared channel (PUSCH) message and a second PUSCH message, wherein the first PUSCH message and the second PUSCH message are associated with different TPC values from the set of TPC values.

11. The network node of claim 10, wherein each of the first PUSCH message and the second PUSCH message includes a demodulation reference signal (DMRS) associated with a different DMRS scrambling parameter.

12. The network node of claim 10, wherein the one or more processors are further configured to cause the network node to:
detect a PRACH collision between the first PRACH message and the second PRACH message based on a difference between a delay of the first PRACH message and a delay of the second PRACH message satisfying a first threshold and a difference between a received power of the first PRACH message and a received power of the second PRACH message satisfying a second threshold.

13. The network node of claim 10, wherein the one or more processors are further configured to cause the network node to:
detect a PRACH collision between the first PRACH message and the second PRACH message based on a difference between a spatial beam of the first PRACH message and a spatial beam of the second PRACH message satisfying a first threshold and a difference between a received power of the first PRACH message and a received power of the second PRACH message satisfying a second threshold.

14. The network node of claim 10, wherein the RAR indicates a set of demodulation reference signal (DMRS) scrambling parameters that are each associated with at least one TPC value in the set of TPC values.

15. The network node of claim 10, wherein at least one of the first PUSCH message or the second PUSCH message includes a DMRS that is associated with a DMRS scrambling parameter selected from the set of DMRS scrambling parameters.

16. The network node of claim 10, wherein the RAR indicates a set of demodulation reference signal (DMRS) scrambling parameters and at least one of the first PUSCH message or the second PUSCH message includes a DMRS associated with a DMRS scrambling parameter selected from the set of DMRS scrambling parameters.

17. The network node of claim 10, wherein the one or more processors are further configured to cause the network node to:
decode one of the first PUSCH message or the second PUSCH message that is associated with a highest power level.

18. The network node of claim 10, wherein the one or more processors are further configured to cause the network node to:
transmit, to a UE, a medium access control control element (MAC-CE) that includes a user resolution identity associated with the PUSCH message.

19. The network node of claim 10, wherein the one or more processors are further configured to cause the network node to:
transmit, to a UE, a secondary TPC configuration for use in one or more transmissions subsequent to a transmission of a PUSCH message from the UE to the network node.

20. A method of wireless communication performed by a user equipment (UE), comprising:
transmitting, to a network node, a physical random access channel (PRACH) message;
receiving, from the network node, a random access response (RAR) indicating a set of transmit power control (TPC) values; and
transmitting, to the network node, a physical uplink shared channel (PUSCH) message using a TPC value selected from the set of TPC values.

21. The method of claim 20, wherein the RAR indicates a set of demodulation reference signal (DMRS) scrambling parameters that are each associated with a TPC value in the set of TPC values.

22. The method of claim 20, wherein the PRACH message is transmitted in a random access channel (RACH) occasion and includes a preamble sequence.

23. The method of claim 20, further comprising:
receiving, from the network node, a medium access control control element (MAC-CE) that includes a user resolution identity associated with the PUSCH message.

24. The method of claim 23, further comprising:
receiving, from the network node, a secondary TPC configuration for use in one or more transmissions subsequent to the PUSCH message.

25. A method of wireless communication performed by a network node, comprising:
receiving a first physical random access channel (PRACH) message associated with a PRACH resource and a second PRACH message associated with the PRACH resource;
transmitting, in response to the first PRACH message and the second PRACH message, a random access response (RAR) indicating a set of transmit power control (TPC) values; and
receiving a first physical uplink shared channel (PUSCH) message and a second PUSCH message, wherein the first PUSCH message and the second PUSCH message are associated with different TPC values from the set of TPC values.

26. The method of claim 25, wherein each of the first PUSCH message and the second PUSCH message includes a demodulation reference signal (DMRS) associated with a different DMRS scrambling parameter.

27. The method of claim 25, further comprising:
detecting a PRACH collision between the first PRACH message and the second PRACH message based on a difference between a delay of the first PRACH message and a delay of the second PRACH message satisfying a first threshold and a difference between a received power of the first PRACH message and a received power of the second PRACH message satisfying a second threshold.

28. The method of claim 25, further comprising:
detecting a PRACH collision between the first PRACH message and the second PRACH message based on a difference between a spatial beam of the first PRACH message and a spatial beam of the second PRACH message satisfying a first threshold and a difference between a received power of the first PRACH message and a received power of the second PRACH message satisfying a second threshold.

29. The method of claim 25, wherein the RAR indicates a set of demodulation reference signal (DMRS) scrambling parameters and at least one of the first PUSCH message or the second PUSCH message includes a DMRS associated with a DMRS scrambling parameter selected from the set of DMRS scrambling parameters.

30. The method of claim 25, further comprising:
decoding one of the first PUSCH message or the second PUSCH message that is associated with a highest power level.
